(19) United States
(12) Patent Application Publication
(10) Pub. No.: US 2013/0268505 A1
(43) Pub. Date: Oct. 10, 2013

(54) SYSTEMS AND METHODS FOR IMPLEMENTING AN ADVANCED USER INTERACTIVE SEARCH ENGINE

(71) Applicant: Michael William URBANSKI, Annapolis, MD (US)

(72) Inventor: Michael William URBANSKI, Annapolis, MD (US)

(21) Appl. No.: 13/902,758

(22) Filed: May 24, 2013

Related U.S. Application Data
(63) Continuation-in-part of application No. 13/893,774, filed on May 14, 2013.
Application No. 13/893,774 is a continuation of application No. 13/542,597, filed on Jul. 5, 2012, now Pat. No. 8,452,659.
Application No. 13/542,597 is a continuation of application No. 13/053,869, filed on Mar. 22, 2011, now Pat. No. 8,452,658.
(60) Provisional application No. 61/381,235, filed on Sep. 9, 2010.

(51) Int. Cl. G06F 17/30

(52) U.S. Cl. CPC G06F 17/30864
USPC 707/706

(57) ABSTRACT

This disclosure relates to a system and method for providing a user with an opportunity to personalize delivered search results of Internet searches in a user-interactive manner that provides a user with an opportunity to qualify or catalog search results according to advanced user preferences. Search engines return thousands of Web pages ordered in a manner that may not be particularly useful to a user in mining the information that the user thought that the user was after when commencing the query-based Internet search. The disclosed embodiments exploit the interactive capabilities of the computing and communicating devices that users typically employ to initiate query-based Internet searches in a manner that allows an individual user, or a group of users, to “rearrange” information that a search engine, according to a scheme implemented by the search engine provider and/or administrator, provides to a user in response to a user's query-based search.

This application is a continuation-in-part of U.S. patent application Ser. No. 13/893,774, filed on May 14, 2013, which is a continuation of U.S. patent application Ser. No. 13/542,597, filed on Jul. 5, 2012, which is a continuation of U.S. Patent Application No. 13/053,869, filed on Mar. 22, 2011, which claims priority from U.S. Provisional Patent Application No. 61/381,235, filed on Sep. 9, 2010, and U.S. Provisional Patent Application No. 61/316,695, filed on Mar. 23, 2010, the disclosures of which are hereby incorporated by reference herein in their entireties.

This application is related to U.S. patent application Ser. No. [Attorney Docket No. 085-0003-CIP2], filed on May 24, 2013, entitled “Systems And Methods For Implementing A User-Directed Landing Page For Generating Enhanced User Contact Information Based On User Interactive Computer Searches,” the disclosure of which is hereby incorporated by reference herein in its entirety.

### BACKGROUND

1. Field of the Disclosed Embodiments

This disclosure relates to systems and methods for providing a user with an opportunity to personalize delivered results responsive to automated data or information requests and/or Internet searches in a user-interactive manner that provides a user, rather than a search engine provider or administrator entity, an opportunity to qualify or catalog the received results according to advanced user preferences.

2. Related Art

A nearly limitless universe of information is available to users via the Internet. Users turn to the Internet as a most readily-available source for entertainment, information exchange, research, and social interaction, and a medium by which users can shop for a best, or most convenient, delivery of any manner of goods and services. The information provided to the user in response to a user-initiated information request may include, not only the specific information for which the user was searching, but may also provide additional information that is intended to be made available to aid the user in making decisions regarding information that the user sought.

Based on the modern availability of a virtually overwhelming amount of information, the concept of “surfing the net” has taken on an even broader scope than originally envisioned. This phrase now refers broadly to user interaction with the Internet using a fixed or mobile workstation, or any manner of handheld communicating device, including, but not limited to, smart phones, PDAs, tablet computers, iPads®, body-worn devices and the like. Users “surf the net” to be entertained, to keep informed, to find specific information regarding particular topics, to shop for goods and services, to interact socially with others, and to perform myriad other tasks. An individual user's experience with the Internet may result in an intellectual timesharing by the user between several tasks, such as those listed above, that the user may undertake in a simultaneous or near-simultaneous manner.

The capacity of a particular user, or category of users, to navigate the nearly limitless expanse of information available via the Internet may be facilitated through user interaction with one or more common search engines. The search engines may include the generally known and broad-based commercial search engines including Google®, Bing®, Yahoo!® and others. Otherwise, the search engines may be more specific, limited in their availability to a particular group of users and/or categorized according to their function, search engine administrator, user audience, targeted subject matter or the like. Users often preferably make use of these more narrowly drawn search engines based on their specificity being particularly to a user's particular area of interest or to a particular subject matter of interest to the user.

Organizations such as the American Bar Association (ABA), the American Medical Association (AMA), and Institute of Electrical and Electronics Engineers (IEEE), to name a few, host their own, often proprietary, search engines. In this regard, professionals of many types including attorneys, medical personnel, engineers and other subscribers may afford themselves of more targeted information that is intended to pertain more directly to their efforts and endeavors. These organizationally-based search engines tend to be specifically responsive to standard inquiries that may be made by the individuals to whom the search engines are targeted. These particular search engines, for example, are more easily able to interpret common words or phrases that are typically employed by individual users to whom the content of these Internet search engines may be directed.

Generally, a user chooses a commercially-available search engine based on its availability and/or familiarity, or on some other metric, which today may include, for example, the last commercial that the user saw regarding the advertised advantages of a particular search engine.

Although often somewhat transparent to individual users, Internet search techniques fall into a number of functional types.

Directory-based search engines were among the first search engines on what was then referred to as the World Wide Web. These were essentially cataloging sites that listed topics by type, in a manner that appeared to emulate an encyclopedic listing of data or, for example, a classification and filing system that might have been found in a brick-and-mortar library. Such a directory-based search engine had the advantages of seeming familiar to individual users and providing to the users lists of categories that, once selected, may display for the users lists of subcategories in order that the users may review information not only on the items of interest, but also on related items according to a broad categorizations.

Web crawlers are a particular type of search engines that systematically browse the World Wide Web, typically for compiling a sort of Web indexing or Web map. These search engines use the Web crawler scheme to update the Web content or to index the Web content. Web crawlers may archive pages for later processing to index the downloaded pages so that users can search them much more quickly. Web crawlers may validate hyperlinks and HTML code.

Query-based search engines are the most common example of a search engine in use today. Query-based search engines afford a user an opportunity to enter one or more search terms as a web search query to satisfy an informational need for the user. As query-based search engines have evolved, they have become the typical search engine of choice by many users. The user enters search terms, most often as plain text terms, with certain characters or connectors added to define the scope of the user-requested search. Query-based search engines may provide information based on certain broad categories of user web search queries, which include: informational queries, which may cover some broad topic such as those that were presented at a highest level in the directory-based search engine hierarchies; navigational queries that may be directed at seeking a single website or a single web page of an individual government, corporate, social, professional or other entity; and transactional queries, most often directed at procuring a particular good or service, including for example purchasing a car or reviewing available real estate in a particular area, according to specific search criteria pertaining to the individually-desired good or service.

In order to gain some commercial advantage, search engine providers or administrators rarely share information regarding searches conducted using their search engines. In this manner, the search engine providers or administrators are able to enhance their “look” to a particular user or group of users by providing to the particular user, or group of users, information that appears more tailored to the particular user, or group of users, based on their previous interaction with the particular search engine. This can be important because individual users most often tend to use extremely truncated search terms, i.e., using individual words, or phrases composed of fewer than five words. Typical users that are not involved in detailed research on a specific topic then are left to sort among the thousands of individually-listed pieces of information that are considered responsive to the user inquiry.

The search engine providers or administrators attempt to filter the information responsive to the user inquiry according to their own interests, and not those of the user. For example, sites that are “preferred” by the search engine providers or administrators may be prioritized over sites that may be more “preferred” by a particular user based on information previously gathered by the search engine providers or administrators. This is often done in order to enhance revenues achievable by the search engine providers or administrators based on their preferable placing of particular responsive sites at a higher priority. Advertisers recognize that such premium placement may be to their advantage because large percentages of users look at only first or second webpages presented in response to their information requests, which may be in the form of query-based searches.

Studies have proven that users tend to be creatures of habit and that a particular user information request may be routinely repeatable, and in response to the information request, a user may tend to select the same results. It is for this reason that an individual search engine provider or administrator may desire to collect information on a user and to place those sites that the user commonly visits in priority immediately after those that generate particular revenue for the search engine provider or administrator. In this manner, a search engine provider or administrator is able to provide a familiar look to a particular user causing a particular user, often out of habit, to return to that particular search engine provider or administrator search engine. The result of this repeatable behavior by individual users, or groups of users, provides the search engine provider or administrator with an opportunity to negotiate with a broader spectrum of commercial entities for advertising space and preferred listing according to the search engine, or on the search engine webpage(s).

Certainly, there are other schemes that search engine providers or administrators may use to enhance a particular user experience in navigating the search engine. Regardless of the schemes employed by search engine providers or administrators, it should be clear from the above discussion that the provision of particular responses to individual user information requests is often to the benefit of the search engine providers or administrators rather than directly to the benefit of the users. This is not to say that certain benefits may not be provided to the users, but rather to indicate that such benefit is subservient to other benefits that may be of concern to the search engine providers or administrators.

Additionally, regardless of how narrowly a particular user attempts to define his or her information request, one having even passing familiarity with the amount of information available on the Internet will quickly realize that an amount of information provided to a particular user in response to a particular information request may be overwhelming. Further, regardless of how carefully the information may be targeted toward responding to the user inquiry, a particular user may be provided information in response to recurring requests for information that result in a first number of responsive pages being repeated over and over for user consumption. Rarely is it a case in which the user can modify the results to the user inquiry very easily as the user is not generally privy to the selection criteria by which the search engine provider or administrator selects its responses.

### SUMMARY OF EMBODIMENTS

As is indicated in the discussion above, and as is otherwise well known to those that conduct searches of the Internet looking to find any specific information, search engines typically return numbers of Web pages in the thousands and order them in a manner that may not be particularly useful to a particular user in mining the particular information that the user thought that he or she was after when commencing the query-based Internet search. It would be advantageous to exploit the interactive capabilities of the computing and communicating devices that users typically employ to initiate query-based Internet searches in a manner that may allow an individual user, or a group of users, to “rearrange” information that a search engine, according to a scheme implemented by the search engine provider or administrator, may provide to a user in response to a user query-based search.

Exemplary embodiments of the systems and methods according to this disclosure may provide users with an ability to manipulate the search engine in a manner that takes power away from the search engine provider or administrator and allows the power of selection, listing cataloging, and/or ordering of search results to reside with the user in a manner that the user may choose to employ.

Exemplary embodiments may provide a user with an opportunity to manipulate results provided by any search engine that the user is employing, and to personalize the search results to user-specific desires without laborious interaction with the search engine itself.

Exemplary embodiments may provide the user with an opportunity to flag particular search results that the user does not consider to be responsive to the user intended inquiry such that those search results may be left off the display in response to a subsequent user query-based search or may be separately displayed in a manner that highlights to the user that the user previously determined that a particular search result, or group of search results, was not responsive to the user search, were of no value to the user or were not to the user's liking.

Exemplary embodiments may extend the opportunity for the user to flag particular search results that the user does not consider to be responsive to the user intended inquiry to additional search results that are related to a particular search result that the user may have flagged according to one or more of the above-listed criteria.

Exemplary embodiments may provide the user with an opportunity to provide, in some manner of standard format text box, free-form text that the user may consider applicable to providing feedback to the user regarding the user's own impressions regarding a value to the user of the returned search results. These free-form text inputs may be a locally stored for presentation to the user in a manner that does not provide any feedback, for example, to the search engine provider or administrator. In other words, the free-form text inputs may be usable by the user in a manner that handwritten notes regarding previous searches may be used by the same user.

Exemplary embodiments may provide the user with an opportunity to “score” (according to some generic rank ordering hierarchy or scheme) the returned search results in a manner that is understandable by the user. Such a scheme would provide a user with the user's own feedback, in a quickly decipherable annotation, of a simple metric by which the user can equally rank one or more particular search results with respect to a value (positive or negative) that the user himself or herself assigns to the particular search results.

Exemplary embodiments may provide a user with the opportunity to enter any of the above schemes to modify the presentation of the results rendered by a particular search engine by any one of a number of fixed or mobile computing or communicating devices including, but not limited to, a desktop computer, a laptop or tablet computer, or any one or more of the class of mobile devices including smartphones, iPhones®, iPads®, PDAs, and the like.

Exemplary embodiments may provide schemes whereby user qualifying, cataloging, referencing and commenting on one or more of the search results provided by a commercially-available, broad-based search engine may be presented in a manner that the user chooses without providing feedback of any kind, including searchable feedback, to a provider or administrator of the search engine.

These and other features, and advantages, of the disclosed systems and methods are described in, or apparent from, the following detailed description of various exemplary embodiments.

### BRIEF DESCRIPTION OF DRAWINGS

Various exemplary embodiments of the disclosed systems and methods for providing a user with an opportunity to personalize delivered search results of Internet searches in a user-interactive manner that provides a user, rather than a search engine provider or administrator entity, an opportunity to qualify or catalog search results according to advanced user preferences will be described, in detail, with reference to the following drawings, in which:

FIG. 1 illustrates a schematic diagram of an exemplary overview of a networked communication environment within which the systems and methods according to this disclosure may operate;

FIG. 2 illustrates a first exemplary embodiment of an automated user interface in the form of a window portion that may be displayed to a user on a device by which the user conducts an automated information request in order that the user may input information to qualify, catalog or otherwise comment on results provided in response to the user information request using the systems and methods according to this disclosure;

FIG. 3 illustrates a second exemplary embodiment of an automated user interface in the form of a tool bar that may be displayed to a user on a device by which the user conducts an automated information request in order that the user may input information to qualify, catalog or otherwise comment on results provided in response to the user information request using the systems and methods according to this disclosure;

FIG. 4 illustrates a block diagram of an exemplary system that provides a mechanism for user interaction by which a user may personalize delivered results of user-initiated automated information requests to qualify or catalog the results according to advanced user preferences according to this disclosure; and

FIG. 5 illustrates a flowchart of an exemplary method for implementing user interaction in which a user may personalize delivered results of user-initiated automated information requests to qualify or catalog the results according to advanced user preferences according to this disclosure.

### DETAILED DESCRIPTION OF EMBODIMENTS

The disclosed systems and methods provide a mechanism for user interaction by which a user may personalize delivered results responsive to user automated information requests, including Internet searches, to qualify or catalog the responsive results according to advanced user preferences, as set forth in this disclosure, will generally refer to this specific utility for those systems and methods. Exemplary embodiments described and depicted in this disclosure should not be interpreted as being specifically limited to any particular communication network configuration, to any particular device or system by which a user may interact with a particular search engine, or to any particular search engine or multiple search engines. In fact, any information exchange capability that may facilitate a user advanced interaction with results rendered by a search engine or that may aid a user in identifying which results, on a recurring basis that a user may find most valuable, or that a user conversely may choose to ignore, are contemplated to be included within the scope of this disclosure.

Specific reference to, for example, any particular communicating or computing device in wired or wireless communication with a search engine in a network environment by which a user automated information request may be initiated, or by which search results displayed to an individual user may be manipulated to the liking of that user should be understood as being exemplary only, and not limited, in any manner, to any particular device or class of devices. The systems and methods according to this disclosure will be described as being particularly adaptable to being hosted on commercially-available hand-held wireless devices, such as smartphones, iPhones®, tablets, iPads®, PDAs, body-worn devices and the like, but should not be considered as being limited to only these classes and/or types of devices.

Individual features and advantages of the disclosed systems and methods will be set forth in the description that follows, and will be, in part, obvious from the description, or may be learned by practice of the features described in this disclosure. The features and advantages of the systems and methods according to this disclosure may be realized and obtained by means of the individual elements and combinations of those elements as particularly pointed out in the appended claims. While specific implementations are discussed, it should be understood that this is done for illustration purposes only. A person skilled in the relevant art will recognize that other components and configurations may be used without departing from the spirit and scope of the subject matter of this disclosure.

Various aspects of the disclosed embodiments relate to a system and a method for providing a mechanism for user interaction by which a user may personalize delivered results of automated user information requests to qualify or catalog the search results according to advanced user preferences. The disclosed scheme allows users to manipulate results provided by a search engine in response to a user information request, while the user is employing the search engine, thereby personalizing the results provided according to a user-interactive scheme. This may be particularly applicable to users conducting automated information requests employing specified search engines in a user's area of interest, or according to subject matter of interest to the user.

As an example of a scenario in which the systems and methods according to this disclosure may be implemented, consider a user doing research on local attorneys in the user's area in an effort to discern an attorney that may be best suited, or otherwise appropriately suited to representing the user in a particular matter. The user may conduct an automated information request, including a query-based Internet search, for a patent attorney in northern Virginia and the District of Columbia. The results provided to the user by the search engine with which the user is conducting his or her search may include a large number of individual listings and a number of Web pages, including, for example, www.Lawyers4U.com in a first or top spot in the received results. The user may select www.Lawyers4U.com based on its placement in the received results only to realize that the website provides a less than useful directory of attorneys nationwide, some of whom advertise themselves as having “Intellectual Property” as a practice area. The user deems that this particular website is not useful in responding directly to his or her information request for a patent attorney in northern Virginia and the District of Columbia. In other words, the user was not looking for a directory, but was rather looking for a patent attorney with a particular expertise in a particular geographic area.

Ignoring www.Lawyers4U.com then, for the moment, the user continues down the list of received results provided by the search engine and clicks on what appears to be a more favorable link only to be returned to some subpage such as www.Lawyers4U.com/profiles.html. The user may not even recognize that the website was one that the user had accessed before only to determine that it was not useful to the user. The title of the website, for example, may have sounded familiar to the user, but the user, having “clicked on” large numbers of links may not be able to remember which links the user liked and which the user did not care for or find useful, much less valuable. The user may then click on www.Lawyers4U.com only to be reminded that user did not find the site useful, valuable, or in fact even responsive to the user's particular information request.

Versions of the above scenario occur countless times a day in the context of individual Internet search sessions or otherwise between Internet search sessions carried out by a single user. When doing research, the user often clicks on another page of the same website without realizing it until the result appears.

The systems and methods according to this disclosure, in embodiments, may provide a solution to the above, all-too-often-experienced dilemma. According to the disclosed schemes, when presented with a less than useful individual result among a list of results, i.e., when the user finds the individual result useless in the context of the user's intended information request, a user may be provided (or may be able to select) a simple automated scheme by which a user interface or a tool bar may be displayed for the user to employ to proactively tag www.Lawyers4U.com in a manner that may remove that result, e.g., the web page (and its related web pages), a particular domain name and related sub-domain names, as results in future information requests conducted by that user.

In embodiments, the disclosed systems and methods may afford the user an opportunity to add comments, using for example a free form text function in a user interface, or available via a tool bar, to the particular responsive result. The added comments may be linked to the particular result in a manner that allows the user to receive future results to user information requests that will be automatically annotated with the user's own previous comments. The addition of the user's comments may allow the user, in the future information requests, to scroll down a page of results and, aided by the user's own notes, to streamline the process of reviewing links that are provided in response to future queries. The free-form nature of the text allows the user to annotate the search results as he or she may deem appropriate, positive or negative. The private nature of the annotations will also not constrain the user from annotating the search results in any manner that he or she deems appropriate. The user will save time by not clicking on something that the user has already determined was of limited or no value to the user, or by proceeding directly to those results that the user previously annotated as having been particularly helpful.

In embodiments, the user could easily numerically score the various sites in some manner that only the user, or others with whom the user may share the scores (including sub-groups, task groups, working groups, organizationally-structured sub-organizations), may be able to see. The scoring scheme may provide a simple and streamlined manner by which to assess a value of a particular site to a particular user at a particular point in time in a manner that is retained to be applied to future received results that may render, for example, the same links. This avoids a need, for example, to construct a separate list of “favorite” links that may, or may not, pertain to a particular search, and that may have to be reviewed separately by the user in a more time-consuming manner to determine whether information responsive to a future information request may be available from any one of the user's “favorite” sites. A capacity to score, or otherwise to add user-formulated descriptive notes to certain received results may supplant a need for certain users to collect favorite sites while leaving open an assessment of results that are currently deemed to be apparently responsive to a user automated information request at any future point in time.

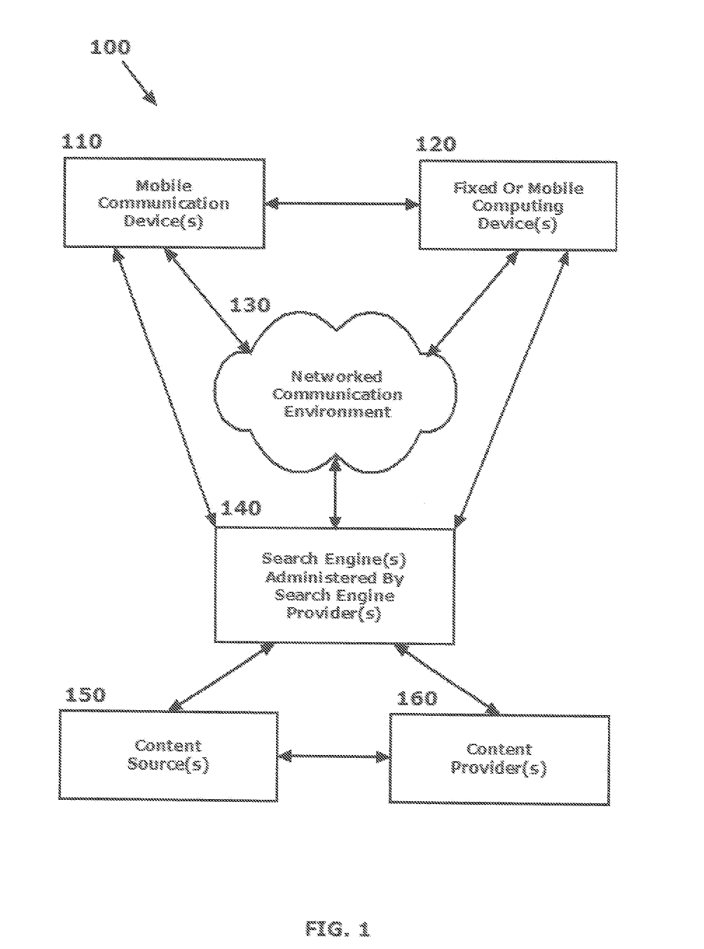

FIG. 1 illustrates a schematic diagram of an exemplary overview 100 of a networked communication environment 130 within which the systems and methods according to this disclosure may operate. As shown in FIG. 1, any one or more of a mobile communication device 110 and a fixed or mobile computing device 120 (or pluralities of each of these classes of devices) may be provided to allow individual users, or groups of users, to gain access to one or more search engines 140, either directly or via at least a networked communication environment 130. Various ones of a mobile communication device 110 and a fixed or mobile computing device 120 may communicate directly with one another to sync the information between the various ones of the devices. Ultimately, the search engines 140, which are administered by one or more search engine providers, may be usable to allow the individual users to gain access to the vast amount of information that is available via the Internet, represented in FIG. 1 as content sources 150 and content providers 160. Using any one or more of the mobile communication device 110 and the fixed or mobile computing device 120, users may conduct automated information requests, including Internet searches. The search engines 140 will return results regarding, for example, links, webpages, domain names, URLs and the like provided as content sources 150, or by content providers 160, that the search engines 140 deem as being responsive to the user information request. As indicated above, an ordering provided by a search engine 140 for display on a display screen associated with the any one or more of the mobile communication device 110 and the fixed or mobile computing device 120 may be according to a rule, scheme or algorithm established by the search engine provider administering the individual search engine 140 that the user has chosen to conduct the search. The ordering of the results provided by the search engine may not be optimal for a particular user. It is this shortfall in current provision of search engine results that the exemplary embodiments according to this disclosure are intended to address.

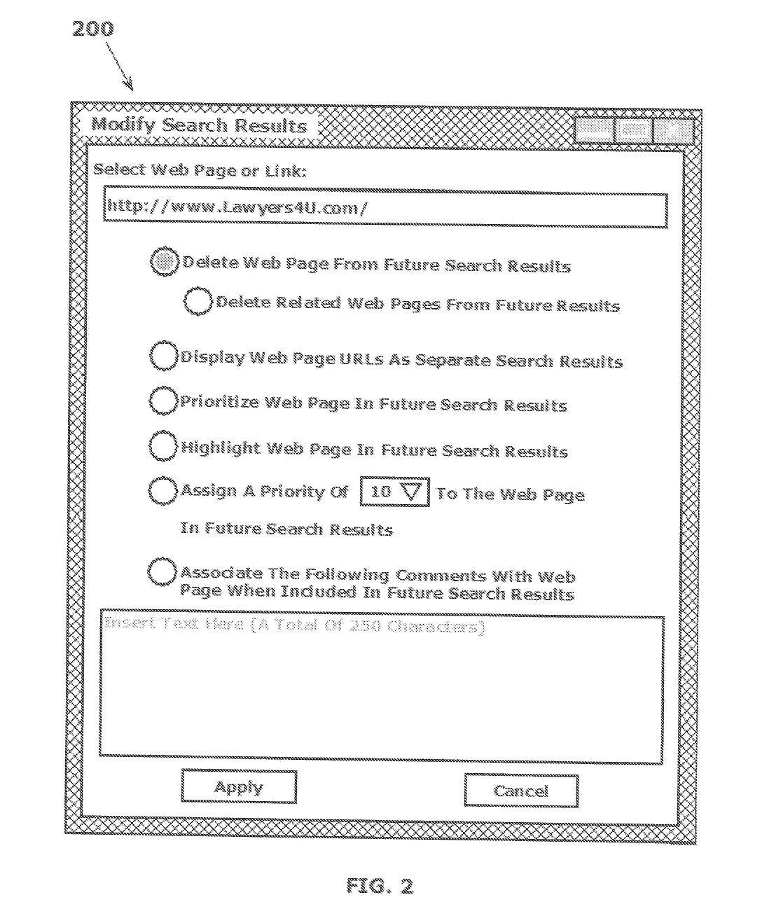

FIG. 2 illustrates a first exemplary embodiment of an automated user interface 200 in the form of a window portion that may be displayed to a user on a device by which the user conducts an automated information request in order that the user may input information to qualify, catalog or otherwise comment on results provided in response to the user information request using the systems and methods according to this disclosure. The exemplary embodiment of the automated user interface 200 shown in FIG. 2 is intended to be representative of a typical user interface that may be presented to the user on a display of the one of the mobile communication device or the fixed mobile computing device to implement portions of the cataloging, scoring, reordering or other user-modification schemes regarding results delivered to the user via search engine as described above. One, some, or all of the options shown in the exemplary embodiment of the automated user interface 200 shown in FIG. 2 may be selectable by the user by clicking on, for example, some general icon, once search results have been delivered to the user in response to an Internet search query. In order that the user may input information to qualify, catalog or otherwise comment on individual results provided in response to a user automated information request using the systems and methods according to this disclosure.

As shown in FIG. 2, a dialog box may be provided by which the user may select a webpage, link, domain name, URL or the like, with which to associate certain information via manipulation of the automated user interface 200. The dialog box may be, for example, automatically populated by the user once in a results modification mode clicking separately on the webpage, link, domain name, URL or the like that the user desires to modify. Otherwise, the user may be afforded the opportunity to type information in the dialog box.

The user may be afforded a series of options by which to modify the results. These options may include one or more of the options shown in the exemplary automated user interface 200 shown in FIG. 2. First, the user may be provided an option to tag a particular webpage, link, domain name, URL or the like in a manner that does not appear in future responsive results. Additionally, the user may be provided a separate option in which related webpages, links, domain names, sub-domains, related URLs and the like may be made to not appear in future responsive results.

Second, with regard to potential deletion from the results of particular webpages, links, domain names, URLs or the like, the user may be provided an option in which those webpages, links, domain names, URLs and the like that the user chooses not to be included in the returned results may be displayed in a separate window, for example, as separate responsive results. In this manner, the user may be afforded an opportunity to segregate those webpages, links, domain names, URLs and the like that the user does not want to be routinely listed as a portion of the results in response to a user-based information request without discarding those webpages, links, domain names, URLs and the like, but rather providing them in a separate window for reference by the user should the user choose to employ such an option.

Third, the user may be provided an option in which selected webpages, links, domain names, URLs or the like may be prioritized in presentation of future responsive results. In this manner, the user is afforded an opportunity to at least partially override the prioritization scheme by which a provider or administrator of the search engine may choose to prioritize the results. It is envisioned that the prioritization scheme may be limited to a particular number of webpages, links, domain names, URLs or the like.

Fourth, the user may be provided an option in which selected webpages, links, domain names, URLs or the like may be highlighted according to some predetermined color scheme, or a color scheme that the user may select. For example, using a standard traffic light methodology, webpages, links, domain names, URLs or the like that the user may consider to be particularly useful may be color-coded green, while webpages, links, domain names, URLs or the like that the user may consider to be of limited use, or not helpful at all, maybe color-coded red. It should be understood that many variations on this theme may be applicable using the automated user interface 200, and other display capabilities of the device that the user chooses to employ to initiate the automated information request and to display the automated user interface 200 for modifying the results returned by the user automated information request.

Fifth, the user may be provided an option in which selected webpages, links, domain names URLs or the like may be assigned a particular alpha-numeric or pictorial (icon-indicated) priority according to, for example, a drop-down menu. In this regard, the user may determine a ranking system for the webpages, links, domain names URLs or the like returned by the search engine. Separately, for example, a user, having modified the returned results to indicate a particular alpha-numeric value associated with one or more selected webpages, links, domain names, URLs or the like may subsequently note that only webpages, links, domain names, URLs or the like of a particular alpha-numeric value, as assigned by the user, should be displayed.

Sixth, the user may be provided an option in which descriptive text/comments may be associated with a particular webpage, link, domain name, URL or the like. In such a scheme, every later return of that particular webpage, link, domain name, URL or the like via the search engine may (1) display the descriptive text/comments for the user to review, or (2) may provide a selectable icon associated with the particular webpage, link, domain name, URL or the like that indicates that descriptive text/comments are available, as previously input by the user. For example, a user may include comments indicating a particular affinity for one or more webpages, links, domain names, URLs or the like and provide further descriptive information that may indicate some portion or page of the webpage or link, or associated with the domain name or URL, that may be of particular interest if returned as responsive to a user automated information request in the future. Conversely, if the user finds nothing helpful in the returned result, the user may indicate this in a manner that is not shared, for example, outside the user's purview, or under the user's direction to a particular sub-group of users. In this manner, the user is afforded an opportunity to place his or her own notes with respect to the value of a webpage, link, domain name, URL or the like in the user's system in a manner that the user may later reference to streamline the user's review of future responsive results.

Having chosen one or more of the available options for modifying the search results according to a user's choosing, those modifications may be applied, or the selections separately canceled, through user manipulation of one or more of the options presented on the automated user interface 200, which may then return the display on the user device back to the search results. According to this methodology, the power to order, qualify or catalog search results is moved from the exclusive control of the search engine provider or administrator to the particular user.

In embodiments, a user may execute some manner of login scheme to gain access to the automated user interface 200.

In embodiments, selections made by a user through interaction with the automated user interface 200 may be manually reset according to a user selection, for example, to clear all actions undertaken via the automated user interface, or ay be commanded to reset according to some preset or predetermined criteria.

It should be appreciated that the above description provides an overview of several options that may be made available to a user. Those of skill in the art will, however, readily recognize that other options for modifying search results within the disclosed scheme may be provided. Portions of the user interface may be on a same display as the search results.

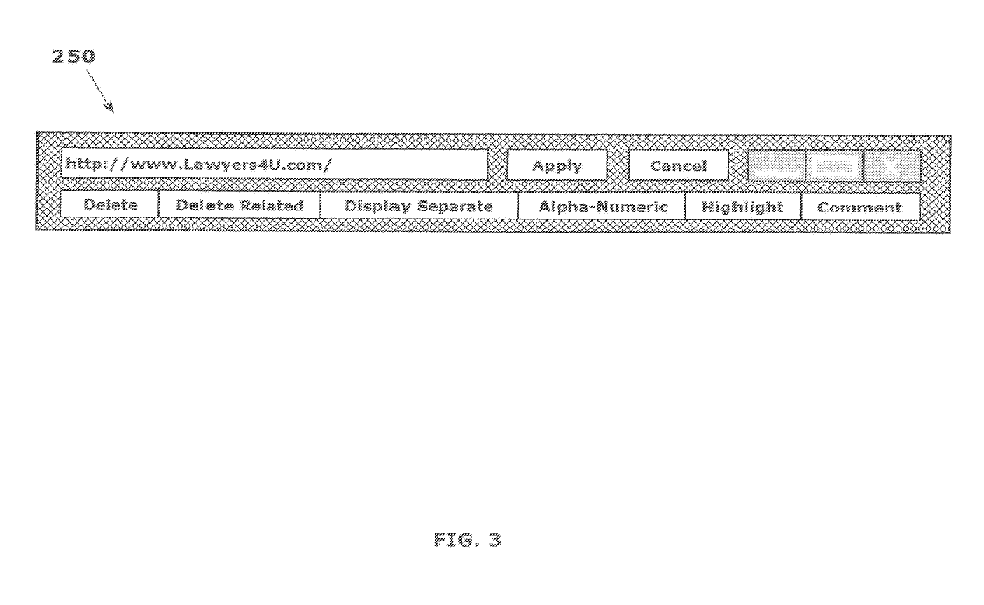

FIG. 3 illustrates a second exemplary embodiment of an automated user interface 250 in the form of a tool bar that may be displayed to a user on a device by which the user conducts an automated information request in order that the user may input information to qualify, catalog or otherwise comment on results provided in response to the user information request using the systems and methods according to this disclosure. According to a user selection, the toolbar may always be displayed over other display items, including lists of webpages, links, domain names URLs and the like, maps and myriad other display compositions that may include selectable information presented to the user on a display device. Individual icons may be activated by the user to carry into effect the same types of options outlined in detail above for the first exemplary embodiment of the user interface. Explanatory nomenclature is included in several of the individual boxes in the depiction in FIG. 3. It should be recognized that the nomenclature may be replaced by icons or other descriptive material by which an action undertaken through user “actuation” of one of the buttons (boxes) may be identified to the user

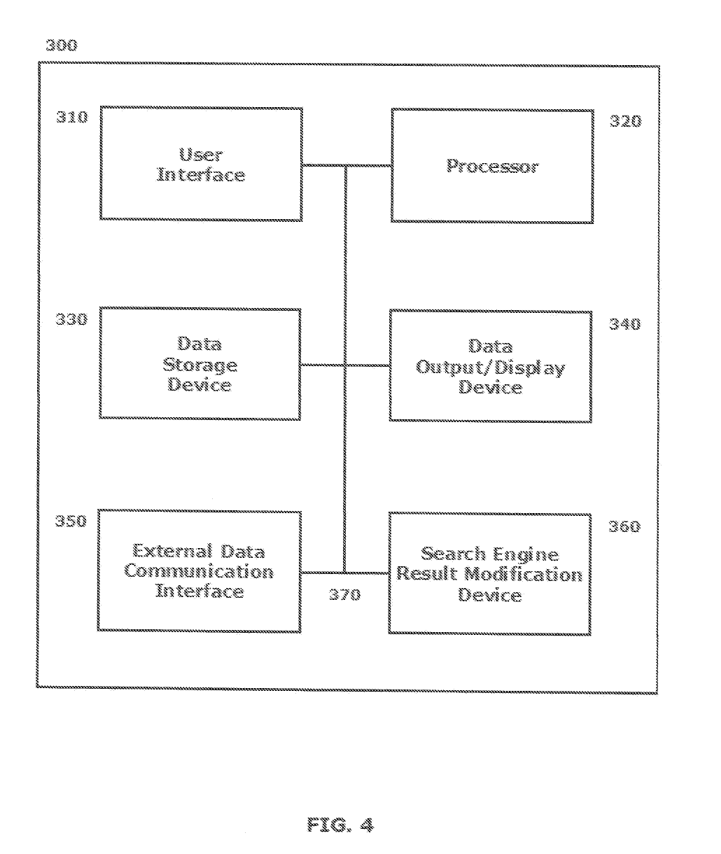

FIG. 4 illustrates a block diagram of an exemplary system 300 that may provide a mechanism for user interaction by which a user may personalize delivered results responsive to a user-initiated automated information request to qualify or catalog the results according to advanced user preferences. The exemplary system 300 shown in FIG. 3 may be embodied in, for example, one or more of a mobile communication device or a fixed or mobile computing device. See generally FIG. 1.

The exemplary system 300 may include a user interface 310 by which the user may communicate with the exemplary system 300. The user interface 310 may be configured as one or more conventional mechanisms that permit a user to input information to the exemplary system 300. The user interface 310 may include, for example, an integral or attached keyboard and/or mouse by which a user may enter data into the exemplary system 300. The user interface 310 may alternatively include (1) a touchscreen with “soft” buttons, or for use with a compatible stylus; (2) a microphone by which a user may provide oral commands to the exemplary system 300 to be “translated” by a voice recognition program or otherwise; or (3) other like devices for user operation of, and data exchange with, the exemplary system 300. The user interface 310 may be integrated into a graphical user interface (GUI) associated with one or more of the mobile communication device or the fixed or mobile computing device operated by the user and of which the exemplary system 300 may be a part or function.

The exemplary system 300 may also include one or more local processors 320 for individually operating the exemplary system 300 and carrying out processing and control functions associated with the disclosed schemes. Processor(s) 320 may include at least one conventional processor or microprocessor that interprets and executes instructions to execute communications and facilitate the determinations and display components for user interaction according to the methods of this disclosure.

The exemplary system 300 may include one or more data storage devices 330. Such data storage devices 330 may be used to store data or operating programs to be used by the exemplary system 300, and specifically the processor 320. Data storage device(s) 330 may include a random access memory (RAM) or another type of dynamic storage device that stores information and instructions for execution by processor(s) 320. Data storage device(s) 330 may also include a read-only memory (ROM), which may include a conventional ROM device or another type of static storage device that stores static information and instructions for processor(s) 320. Further, the data storage devices 330 may be integral to the exemplary system 300, or may be provided external to, and in wired or wireless communication with, the exemplary system 300.

At least one of the data storage devices 330 may be configured to accept and store user inputs regarding modification of the received results based on user interaction with, for example, a displayed automated user interface. The at least one of the data storage devices 330 may, for example, include a database that lists webpages, links, domain names, URLs or the like that the user has chosen to add modifications to according to any one or more of the above-discussed options. The database may then include the information that the user has input to be associated with the listed webpages, links, domain names, URLs or the like.

The exemplary system 300 may include at least one data output/display device 340 which may be configured as one or more conventional mechanisms that output information to the user or that otherwise provide a mechanism by which the user may interact for information exchange with the exemplary system 300 according to known methods.

The exemplary system 300 may include one or more external data communication interfaces 350 by which the exemplary system 300 may communicate with components external to the exemplary system 300 including other communication devices with which the exemplary system 300 may be in wired or wireless communication. It is via these external data communication interfaces 350, for example, that the exemplary system 300 uses to communicate with the one or more search engines, the results of which the user may modify according to the systems and methods of this disclosure. External data communication interface(s) 350 may include any mechanism that facilitates direct communication, or communication via a network environment, for interaction with the search engines.

The exemplary system 300 may include a search engine result modification device 360 that is usable to specifically implement the search result modification schemes according to this disclosure. Components of the search engine result modification device 360 may include the mechanisms for generating an automated user interface and for accepting user input via that automated user interface, as discussed above with reference to the depiction in FIG. 2. Additionally, components of the search engine result modification device 360 may include a specifically segregated storage device in which a database such as that discussed above may be housed.

All of the various components of the exemplary system 300, as depicted in FIG. 4, may be connected by one or more data/control busses 370. These data/control busses 370 may provide wired or wireless communication between the various components of the exemplary system 300, whether all of those components are housed integrally in, or are otherwise external and connected to, any communicating or computing device with which the exemplary system 300 is associated.

It should be appreciated that, although depicted in FIG. 4 as an integral unit, the various disclosed elements of the exemplary system 300 may be arranged in any combination of sub-systems as individual components or combinations of components, integral to a single unit, or external to, and in wired or wireless communication with, the single unit of the exemplary system 300. In other words, no specific configuration as an integral unit, or as a support unit, in communication with other units or devices is to be implied by the depiction in FIG. 4.

It should also be appreciated that the system storage and processing functions described above, given the proper inputs, may be carried out in system hardware circuits, software modules or instructions, or firmware, or in varying combinations of these.

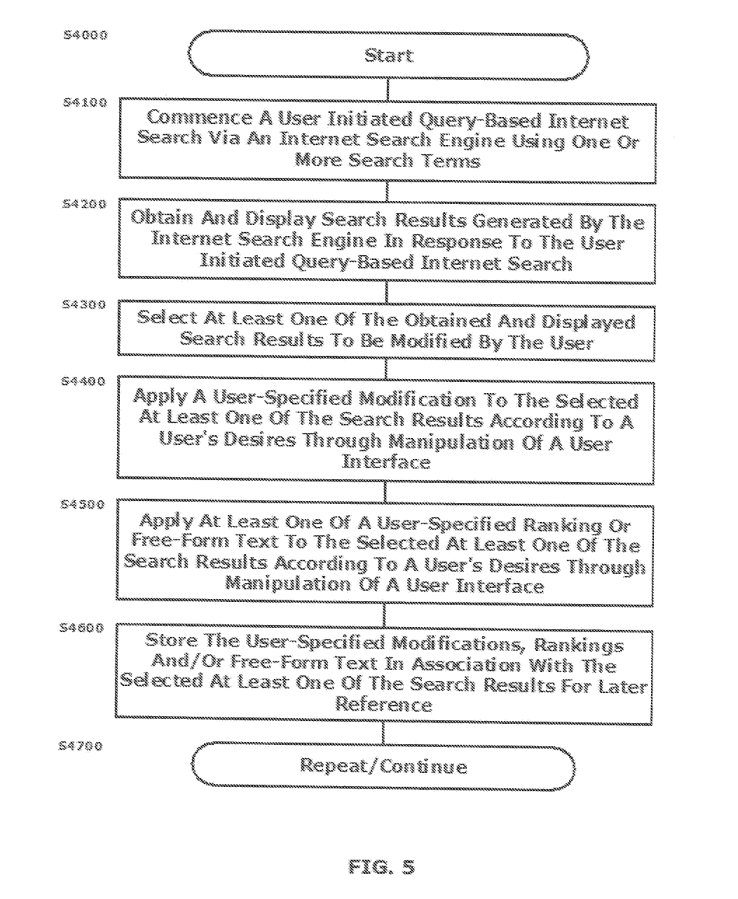

The exemplary embodiments may include a method for implementing user interaction in which a user may personalize delivered results responsive to user-initiated automated information requests, including Internet searches, to qualify or catalog the results according to advanced user preferences. FIG. 5 illustrates a flowchart of such an exemplary method as discussed in this disclosure. As shown in FIG. 5, operation of the method commences at Step S4000 and proceeds to Step S4100.

In Step S4100, a user may initiate an automated information request via an Internet search engine using, for example, one or more search terms. Operation of the method proceeds to Step S4200.

In Step S4200, responsive results generated by the Internet search engine in response to the user-initiated automated information request may be returned by the search engine and displayed on a display screen of the communicating or computing device by which the user initiated the information request. Operation of the method proceeds to Step S4300.

In Step S4300, a user may select at least one of the displayed responsive results, e.g., a webpage, link, domain name, URL or the like, for modification by the user via, for example, an automated user interface that can be separately or additionally displayed to the user as a window portion or a toolbar on a standard display device. Operation of the method proceeds to Step S4400.

In Step S4400, a user-specified modification to the selected at least one of the responsive results may be applied according to a user desires through manipulation of the automated user interface that is separately or additionally displayed to the user. The user-specified modification may be according to one or more of the options discussed above with reference to FIG. 2. Operation of the method proceeds to Step S4500.

In Step S4500, a user-specified ranking or user-generated free-form text may be separately or additionally applied to the selected at least one of the responsive results according to the user desires through manipulation of the automated user interface displayed to the user for such interaction. As a result of either or both of the modifications or additions made in Steps S4400 and 4500, a display of the search engine results may be cooperatively modified under user control rather than under the control of the provider or administrator of the search engine. Operation of the method proceeds to Step S4600.

In Step 4600, the user-specified modifications or additions may be stored in association with an indication of the webpage, link, domain name, URL or the like to which they are applicable in order that, when the same webpage or link is returned in response to a future information request initiated by a same user, the same webpages, links, domain names, URLs or the like may be annotated with the modifications previously assigned by the user. Operation of the method proceeds to Step S4700, where operation of the method is made to repeat or continue.

The disclosed embodiments may include a non-transitory computer-readable medium storing instructions which, when executed by a processor, may cause the processor to execute the steps of the method described above.

Overall benefits of the disclosed embodiments may include simple and practical mechanisms by which a user may customize results responsive to an automated information request according to a predetermined and/or disciplined scheme in order that the user may take control of a display of the results to his or her liking.

The above-described exemplary systems and methods referenced certain conventional components to provide a brief, general description of a suitable communication and processing environment in which the subject matter of this disclosure may be implemented for familiarity and ease of understanding. Although not required, embodiments of the disclosure may be provided, at least in part, in a form of hardware circuits, firmware or software computer-executable instructions to carry out the specific functions described, such as program modules, being executed by a processor. Generally, program modules include routine programs, objects, components, data structures, and the like that perform particular tasks or implement particular data types.

Those skilled in the art will appreciate that other embodiments of the disclosed schemes and techniques may be practiced in computing and communication network environments with many types of communication equipment and supporting computer system configurations, including personal computers, hand-held devices, multi-processor systems, microprocessor-based or programmable consumer electronics, and the like.

Embodiments may also be practiced in distributed communication and computing environments where tasks are performed by local and remote processing devices that are linked to each other by hardwired links, wireless links, or a combination of both through a communication network. In a distributed communication and/or computing environment, program modules may be located in both local and remote memory storage devices.

Embodiments within the scope of this disclosure may also include non-transitory computer-readable media having stored computer-executable instructions or data structures that may be accessed, read and executed by the user's local wireless communication device using a compatible wired or wireless data reader. Such computer-readable media may be any available media that may be accessed by a processor, general purpose or special purpose computer in, or in communication with, the user's local wireless communication device. By way of example, and not limitation, such computer-readable media may comprise RAM, ROM, EEPROM, CD-ROM, flash drives, data memory cards or other analog or digital data storage device that may be used to carry or store desired program elements or steps in the form of accessible computer-executable instructions or data structures. When information is transferred or provided over a network or another communications connection, whether wired, wireless, or in some combination of the two, the receiving processor properly views the connection as a computer-readable medium. Thus, any such connection is properly termed a computer-readable medium. Combinations of the above should also be included within the scope of the computer-readable media for the purposes of this disclosure.

Computer-executable instructions include, for example, non-transitory instructions and data that may be executed and accessed respectively to cause any of the described communication devices, or processors associated with such devices, to perform certain of the above-specified functions, individually, or in combination. Computer-executable instructions also include program modules that are remotely stored for access by the described communication and/or computing devices to be executed by the processors in the described communication and/or computing devices when the devices are caused to communicate in a network environment. The exemplary depicted sequence of executable instructions or associated data structures represents one example of a corresponding sequence of acts for implementing the functions described in the steps. Not only steps need to be executed in order to be considered as completing the disclosed method. Also, no particular order to the method steps is to be implied by the depiction in FIG. 5, and the company description, except where completion of a particular method step is a necessary precondition to completion of a subsequent method step.

Although the above description may contain specific details, they should not be construed as limiting the claims in any way. Other configurations of the described embodiments of the disclosed systems and methods are part of the scope of this disclosure. For example, the principles of the disclosure may be applied to each individual user where each user may individually deploy such a system or method to initiate query-based Internet searches and to modify the results received from a search engine in response to the user query-based Internet search. This enables each user to use the benefits of the disclosure even if any one of the large number of possible applications do not need a specific aspect of the functionality described and depicted in this disclosure. In other words, there may be multiple instances of the described components each processing information content in various possible ways. It does not necessarily need to be one system used by all end users. Accordingly, the appended claims and their legal equivalents should only define the disclosure, rather than any specific examples given.

We claim:

1. A method for modifying a presentation of results responsive to a user-initiated automated information request, comprising:
receiving results responsive to a user-initiated automated information request with a device;
displaying the received results on a display portion of the device;
providing, with the processor, an automated user interface on a display portion of the device, the automated user interface providing the user with one or more options for modifying the received results according to user preferences;
receiving, with the processor, a selection of at least one of the received results to be modified;
receiving, with the processor via a user-manipulated input portion of the device, selected user preferences for modifying the selected at least one of the received results to be modified; and
displaying the received results as modified by the user on the display portion of the device.

2. The method of claim 1, the information request being initiated by the user in communication with a particular search engine via the device, the user inputting one or more search terms to the search engine through the user-manipulated input portion of the device, and the search engine returning the results responsive to the information request.

3. The method of claim 2, the search engine being particularly tailored to one of a user's area of interest or a subject matter of interest to a user.

4. The method of claim 1, the automated user interface being selectable by the user for display on the display portion of the device.

5. The method of claim 4, the automated user interface being selectably displayed as one of a window display portion or a tool bar.

6. The method of claim 1, the received results comprising at least one of (1) a list of a plurality of individual web pages, a plurality of individual links, a plurality of individual domain names, a plurality of individual online applications and a plurality of individual uniform resource locators (URLs), (2) a plurality of individual location identifiers on a map display, or (3) a plurality of individual icons on a specified background display, the selected user preferences for modifying the selected at least one of the received results to be modified comprising modifying one of the at least one of the plurality of individual web pages, the plurality of individual links, the plurality of individual domain names, the plurality of individual online applications the plurality of individual URLs, the plurality of individual location identifiers or the plurality of individual icons in the received results.

7. The method of claim 6, the selected user preferences for modifying the selected at least one of the received results to be modified comprising modifying all occurrences of the at least one of the plurality of individual web pages, the plurality of individual links, the plurality of individual domain names, the plurality of individual online applications, the plurality of individual URLs, the plurality of individual location identifiers or the plurality of individual icons in the received results.

8. The method of claim 6, the selected user preferences for modifying the selected at least one of the received results to be modified comprising modifying individual web pages, individual links, individual domain names, individual sub-domains, individual online applications, individual URLs, individual location identifiers or individual icons in the received results that are substantially related to the one of the at least one of the plurality of individual web pages, the plurality of individual links, the plurality of individual domain names, the plurality of individual online applications, the plurality of individual URLs, the plurality of individual location identifiers or the plurality of individual icons that are modified in the received results.

9. The method of claim 1, the selected user preferences for modifying the selected at least one of the received results to be modified comprising marking the selected at least one of the received results to be excluded from being displayed in the as modified received results.

10. The method of claim 1, the selected user preferences for modifying the selected at least one of the received results to be modified comprising marking the selected at least one of the received results to be separately displayed in a display window separate from a display window that displays the as modified received results.

11. The method of claim 1, the selected user preferences for modifying the selected at least one of the received results to be modified comprising marking the selected at least one of the received results to be placed in priority when displaying the as modified received results.

12. The method of claim 1, the selected user preferences for modifying the selected at least one of the received results to be modified comprising visually highlighting the selected at least one of the received results using a different format or color for the font indicating the selected at least one of the received results when displaying the as modified received results.

13. The method of claim 1, the selected user preferences for modifying the selected at least one of the received results to be modified comprising assigning an alpha-numeric score to the selected at least one of the received results, the alpha-numeric score being displayed in association with the selected at least one of the received results when displaying the as modified received results.

14. The method of claim 13, the alpha-numeric score being displayed as at least one of a number, a letter, an icon or a pictorial display identifier.

15. The method of claim 1, the selected user preferences for modifying the selected at least one of the received results to be modified comprising associating free-form text comments with the selected at least one of the received results, the free-form test comments being displayed in association with the selected at least one of the received results when displaying the as modified received results.

16. The method of claim 1, further comprising:
storing received selected user preferences for modifying the selected at least one of the received results to be modified in association with the selected at least one of the received results to be modified in a data storage device to indicate that the user has previously modified the received results;
referencing, with the processor, the data storage device to associate previously received selected user preferences for modifying the selected at least one of the received results to be modified when a current search returns results that include a previously modified selected at least one of the received results;
associating, with the processor, in the current search results, stored previously received selected user preferences for modifying the selected at least one of the received results; and
displaying the current search results as previously modified by the user on the display portion of the device.

17. A device for modifying a presentation of results responsive to a user-initiated automated information request, comprising:
a communication interface by which the device communicates with one or more search engines to transmit information for a user-initiated automated information request and to receive results responsive to the information request;
a user input portion that accepts user input of terms for initiating the information request with the one or more search engines and that accepts input of user preferences for modifying received results responsive to the information request;
a display portion that displays (1) the received results, (2) an automated user interface for user interaction to modify the received results, and (3) as modified received results according to the user preferences;
a processor that is programmed to
generate the automated user interface for display on the display portion of the device, the automated user interface providing the user with one or more options for modifying the received results according to the user preferences;
receive a selection of at least one of the received results to be modified and selected user preferences for modifying the selected at least one of the received results to be modified; and
modify the display of the received results on the display portion of the device according to the selected user preferences for modifying the selected at least one of the received results to be modified.

18. The device of claim 17, the device communicating with a search engine that is particularly tailored to one of a user's area of interest or a subject matter of interest to a user.

19. The device of claim 17, the automated user interface being selectable by the user via the user input portion for display on the display portion of the device.

20. The device of claim 19, the automated user interface being selectably displayed as one of a window display portion or a tool bar.

21. The device of claim 17, the received results comprising at least one of (1) a list of a plurality of individual web pages, a plurality of individual links, a plurality of individual domain names, a plurality of individual online applications and a plurality of individual uniform resource locators (URLs), (2) a plurality of individual location identifiers on a map display, or (3) a plurality of individual icons on a specified background display, the selected user preferences for modifying the selected at least one of the received results to be modified comprising modifying one of the at least one of the plurality of individual web pages, the plurality of individual links, the plurality of individual domain names, the plurality of individual online applications, the plurality of individual URLs, the plurality of individual location identifiers or the plurality of individual icons in the received results.

22. The device of claim 21, the selected user preferences for modifying the selected at least one of the received results to be modified comprising modifying all occurrences of the at least one of the plurality of individual web pages, the plurality of individual links, the plurality of individual domain names, the plurality of individual online applications, the plurality of individual URLs, the plurality of individual location identifiers or the plurality of individual icons in the received results.

23. The device of claim 21, the selected user preferences for modifying the selected at least one of the received results to be modified comprising modifying individual web pages, individual links, individual domain names, individual sub-domains, individual online applications, individual URLs, individual location identifiers or individual icons in the received results that are substantially related to the one of the at least one of the plurality of individual web pages, the plurality of individual links, the plurality of individual domain names, the plurality of individual online applications, the plurality of individual URLs, the plurality of individual location identifiers or the plurality of individual icons that are modified in the received results.

24. The device of claim 17, the selected user preferences for modifying the selected at least one of the received results to be modified comprising marking the selected at least one of the received results to be excluded from being displayed in the as modified received results.

25. The device of claim 17, the selected user preferences for modifying the selected at least one of the received results to be modified comprising marking the selected at least one of the received results to be separately displayed in a display window separate from a display window that displays the as modified received results.

26. The device of claim 17, the selected user preferences for modifying the selected at least one of the received results to be modified comprising marking the selected at least one of the received results to be placed in priority when displaying the as modified received results.

27. The device of claim 17, the selected user preferences for modifying the selected at least one of the received results to be modified comprising visually highlighting the selected at least one of the received results using a different format or color for the font indicating the selected at least one of the received results when displaying the as modified received results.

28. The device of claim 17, the selected user preferences for modifying the selected at least one of the received results to be modified comprising assigning an alpha-numeric score to the selected at least one of the received results, the alpha-numeric score being displayed in association with the selected at least one of the received results when displaying the as modified received results.

29. The device of claim 28, the alpha-numeric score being displayed as at least one of a number, a letter, an icon or a pictorial display identifier.

30. The device of claim 17, the selected user preferences for modifying the selected at least one of the received results to be modified comprising associating free-form text comments with the selected at least one of the received results, the free-form test comments being displayed in association with the selected at least one of the received results when displaying the as modified received results.

31. The device of claim 17, further comprising a data storage device that stores received selected user preferences for modifying the selected at least one of the received results to be modified in association with the selected at least one of the received results to be modified to indicate that the user has previously modified the received results,
the processor being further programmed to
reference the data storage device to associate previously received selected user preferences for modifying the selected at least one of the received results to be modified when a current search returns results that include a previously modified selected at least one of the received results;
associate, in the current search results, stored previously received selected user preferences for modifying the selected at least one of the received results; and
modify a display of the current search results on the display portion of the device to include stored previously received selected user preferences for modifying the selected at least one of the received results.

32. A non-transitory computer-readable medium storing instructions which, when executed by a processor, cause the processor to execute a method for modifying a presentation of results responsive to a user-initiated automated information request, comprising:
receiving results responsive to a user-initiated automated information request with a device;
displaying the received results on a display portion of the device;
providing an automated user interface on a display portion of the device, the automated user interface providing the user with one or more options for modifying the received results according to user preferences;
receiving a selection of at least one of the received results to be modified;
receiving, via a user-manipulated input portion of the device, selected user preferences for modifying the selected at least one of the received results to be modified; and
displaying the received results as modified by the user on the display portion of the device.

33. The non-transitory computer readable medium of claim 32, the method further comprising:
storing received selected user preferences for modifying the selected at least one of the received results to be modified in association with the selected at least one of the received results to be modified in a data storage device to indicate that the user has previously modified the received results;
referencing the data storage device to associate previously received selected user preferences for modifying the selected at least one of the received results to be modified when a current search returns results that include a previously modified selected at least one of the received results;
associating in the current search results, stored previously received selected user preferences for modifying the selected at least one of the received results; and
displaying the current search results as previously modified by the user on the display portion of the device.
